(19) United States
(12) Patent Application Publication
(10) Pub. No.: US 2011/0145355 A1
(43) Pub. Date: Jun. 16, 2011

(54) System and Method for Improved Social Networking

(76) Inventor: Jeremy Mattern, Houston, TX (US)

(21) Appl. No.: 13/031,442

(22) Filed: Feb. 21, 2011

Related U.S. Application Data
(63) Continuation-in-part of application No. 12/875,589, filed on Sep. 3, 2010.
(60) Provisional application No. 61/239,631, filed on Sep. 3, 2009.

(51) Int. Cl. G06F 15/16

(52) U.S. Cl. 709/206

(57) ABSTRACT

A geographically defined social network is provided, the network including a personal communications device; a means for detection of data regarding a first networked user based on a predetermined geographic condition, and a means for delivery of said data regarding said first networked user to a second networked user in response to a geographically-defined user request. Other, “layered” options in which information originally concealed by the first user can be selectively revealed to subsequent users, and a wide variety of selection and data distribution criteria are also provided.

### CROSS-REFERENCE TO RELATED APPLICATIONS

The present application is a continuation-in-part of U.S. Non-Provisional application Ser. No. 12/875,589 filed Sep. 3, 2010, still pending, which claims the benefit of prior provisional application No. 61/239,631 filed Sep. 3, 2009.

### FIELD OF THE INVENTION

The present invention relates generally to an improved social networking system, and in a particular though non-limiting embodiment to a method of meeting people, learning about people, and/or sharing contact information with people that are geographically situated relatively near one other.

### BACKGROUND OF THE INVENTION

Many on-line social networking systems currently exist, with many directed toward specific target audiences, while others are provided for the general use of individuals irrespective of characteristics that might be shared by other users of the network.

For example, there are social networks for groups or individuals who went to the same schools, those who share the same hobbies or commercial interests, etc. Other social networks operate in such a manner that virtually anyone can register and become a member of a broader, disparate community in which posting space is provided for more or less any member willing to follow the rules of the web site and/or pay whatever fees are requested by the site proprietor or administrator for the privilege of being a member.

Some of the more popular social network environments comprise dating sites and/or sites on which members can meet and then communicate with one another on-line; others facilitate arrangement of a more private environment in which the participants can communicate, e.g., by means of electronic mail, instant messaging, etc.

While there have been social networking sites that encourage participation from certain approximate geographical locations, there have to date been no social networking systems in which a means for detection of data regarding a first networked user is based on a predetermined geographic condition, and a means for delivery of data regarding that user is sent to a second networked user in response to the geographically-defined user request.

### SUMMARY OF THE INVENTION

According to one detailed example embodiment, a geographically defined social network is provided, the network including a personal communications device; a means for detection of data regarding a first networked user based on a predetermined geographic condition; and means for delivery of said data regarding said first networked user to a second networked user in response to a geographically-defined user request.

### DESCRIPTION OF SEVERAL EXAMPLE EMBODIMENTS

According to a presently preferred embodiment, the present invention comprises the use of a personal communication device (hereinafter a “PCD”) such as cellular telephones or other devices that connect to a public or private network, including but not limited to the public Internet, radio communications, cellular networks, physically wired networks (including local area networks), wireless networks (including WIFI, BlueTooth, etc.), short range radio communications, and/or virtually any other type of wireless communication method.

In one embodiment, the PCD has the ability, whether by means of an internal GPS receiver, signal strength based radio signal positioning, and/or radio tower proximity detection, to detect approximate geographic location. In an alternative embodiment, a public or private network in communication with the PCD provides the PCD with the approximate geographic location.

In either embodiment, the PCD can ascertain and communicate to a user or remote computer data indicative of a last known geographic location associated with the detected or obtained information. For the balance of this disclosure, the approximate last known location will be referred to as the “LKL.” As will be appreciated by one of ordinary skill in the pertinent arts, the core elements required to practice the instant invention are: a PCD, a network, and a LKL.

According to one exemplary embodiment, a software application (hereinafter “the Application”) is placed on a PCD by means of either a download from a public or private network, or by means of an interface with a computer. The Application is capable of transmitting the LKL of the PCD to a remotely located computer server consisting of one or more conventional servers or a cloud computing environment (all such computer devices hereafter referred to collectively as the “Server”).

The Application also causes one or more identified LKLs to be stored within storage on the Server, such as an SQL, MySQL, Oracle, or any other suitable database or the like, or a similar distributed file system method of storing data, including a cloud and/or other architectures now emerging as viable technological alternatives to databases (all such structures hereafter being referred to collectively as “the Database.”)

The Application commits information directly to the Database, or indirectly to the Database by means of a Server based software application (including an Internet website application, a web service, or any other like alternative). In one embodiment, the Application reports the LKL by one (or both) of an active means and/or a passive means, “passive” in this context referring to a software program or package being run as a background application.

Using either the Application or an Internet available interactive website (hereinafter the “Website”), individual users (which may consist of either individual people or group entities, including commercial entities) create a unique profile, which is transmitted via the Network to the Database whenever a profile is newly created or later updated. In various embodiments, the Profile includes one or more combinations of the following representative (though non-exhaustive) types of data:
First Name, Last Name, Handle, Nickname, and/or combinations thereof
Age, Date of Birth, and/or combinations thereof
Sexual orientation
Race
Gender
Physical characteristics and phenotypes, such as “build,” hair color, eye color, height, apparent physical behaviors, and/or combinations thereof
Relationship status (i.e., married, single, committed relationship, swinger, open relationship, divorced, etc.)
City and State of residence or combinations thereof
City or State of hometown or combinations thereof
Occupation or student status or combinations thereof
Current educational institution or former educational institutions and/or combinations thereof
A primary photograph (which shall serve as a default photograph) and other additional photographs as uploaded by a user, and/or combinations thereof
One or more telephone numbers
One or more website links
One or more email addresses
One or more social networking site links, such as MySpace™, Facebook™, Twitter™, etc., and/or combinations thereof
A search radius (hereinafter “Radius”) to indicate an approximate distance a user wishes to search when locating other potential nearby users (hereinafter “Neighbors”)
A visible or invisible (or private) indicator to allow the Server Application to distinguish between users wishing to be “seen” (i.e., transparent to other users of the system) and those who do not wish to be seen by others

As will be readily appreciated by those of skill in the art, any of the above items can be omitted (or others added) from the Profile without departing from the scope of the invention, and the representative profile data suggested above are not required data elements.

It is presently contemplated that the Application running on the PCD will ultimately transmit the LKL to a server via the network (e.g., the Internet). Using the LKL, the server determines the location of all other users (again, “Neighbors”) of the Application that fall within a user specified Radius based on the Neighbors' LKL. The server will return to the Application a list of all Neighbors whose LKL fall within the search radius, and those whose profile does not indicate an invisible or private status. The returned list can consist of any of the following types of data, or of course various combinations thereof as well as still other types of data consistent with the broad scope of this disclosure:
Any of the items contained in the Profile of the Neighbors
The Neighbors' approximate distance from the LKL of the current user
The approximate or actual time the LKL was last updated by the Neighbors

Information not contained in the initial listing, but contained in the Neighbors' profile and not designated as private, can be seen by a user by selecting a desired Neighbor from the list. The user may then permissively perform one or more of the following tasks, amongst others, with respect to a particular Neighbor:
1. Hide or block the users profile from the Neighbor
2. Place a call to the Neighbor if the Neighbor's phone number is provided
3. Start a textual conversation with the Neighbor
4. Start a private voice conversation with the Neighbor that does not require disclosure of the user or the Neighbor's phone number to each other
5. Send an email to a Neighbor at one or more of the email addresses stored in the Database under the Neighbor's profile, or, in the case where a Neighbor has elected to keep their email address private, allow the user to send a message over the network to the server, which will then be delivered to the Neighbor without disclosing the Neighbor's email address to the user
6. Follow a link to a social networking site listed by the Neighbor
7. Send the Neighbor's Profile and contact information to the user's email address
8. Add a Neighbor's contact information to the user's PCD contact list
9. Unlock private photos of the user stored in the Database that are designated as private for the Neighbor
10. Add the Neighbor to the Database as a friend, buddy, acquaintance, or other authorized contact of the user, for the purpose of disclosing other information contained in the Database, designated by the user as private information.

According to a presently preferred embodiment, some or all of the information contained in the user's Profile can be stored in the Database, and can be modified using the PCD by means of the Application or by means of the Website.

The foregoing specification is provided for illustrative purposes only, and is not intended to describe all possible aspects of the present invention. Moreover, while the invention has been shown and described in detail with respect to several exemplary embodiments, those of ordinary skill in the art will appreciate that minor changes to the description, and various other modifications, omissions and additions may also be made without departing from either the spirit or scope thereof.

1. A geographically defined social network, comprising:
a personal communications device;
means for detection of data regarding a first networked user based on a predetermined geographic condition; and
means for delivery of said data regarding said first networked user to a second networked user in response to a geographically-defined user request.

2. The social network of claim 1, wherein said means for detection further comprises means for determining a last known location of said first networked user.

3. The social network of claim 1, wherein said means for detection further comprises means for determining a last known location for said second networked user.

4. The social network of claim 1, further comprising means for establishing a voice-based communication service between said first networked user and said second networked user without disclosing origination data regarding said first networked user.

5. The social network of claim 1, further comprising means for establishing a private electronic mail service between said first networked user and said second networked user without disclosing said first networked user's originating electronic mail address.

6. The social network of claim 1, further comprising means for establishing a text messaging service between said first networked user and said second networked user without disclosing data regarding the source of said first networked user's originating text address.

7. The social network of claim 1, further comprising an internal contact list, wherein networked users may save and store other networked users' contact information.

8. The social network of claim 1, wherein said data comprises a social networking profile created by said first networked user.

9. The social network of claim 8, wherein said social networking profile comprises said first networked user's preferred sexual orientation.

10. The social network of claim 8, wherein said social networking profile comprises said first networked user's city and state of residence.

11. The social network of claim 8, wherein said social networking profile comprises said first networked user's associated educational institutions.

12. The social network of claim 8, wherein said social networking profile further comprises picture images maintained in locked files that may be unlocked for access by other networked users.

13. The social network of claim 8, wherein said social networking profile is linked to a web-based social networking site.

14. The social network of claim 13, wherein said web-based social networking site is accessible to said second networked user by clicking on an associated hyperlink.
